(19) United States
(12) Patent Application Publication
(10) Pub. No.: US 2022/0095670 A1
(43) Pub. Date: Mar. 31, 2022

(54) FINGER-OPERATED HERB GRINDER

(71) Applicant: Eduardo Fausto-Contreras, Las Vegas, NV (US)

(72) Inventor: Eduardo Fausto-Contreras, Las Vegas, NV (US)

(21) Appl. No.: 17/142,239

(22) Filed: Jan. 6, 2021

Related U.S. Application Data
(60) Provisional application No. 63/204,357, filed on Sep. 29, 2020.

(51) Int. Cl. A24B 7/00; B02C 18/04

(52) U.S. Cl. CPC A24B 7/00; B02C 18/04

(57) ABSTRACT

A finger-operated herb grinder; the finger-operated herb grinder includes a grinder assembly having a top-platform and a mating bottom-platform connected by a connecting strap. The top-platform includes a top-grinding nodule and a finger retaining strap and the bottom-platform includes a bottom-grinding nodule, a hollow inner volume, a thumb retaining strap. A dispensing aperture is formed between the top-platform and the bottom-platform and is configured to dispense grinded-material therethrough. The top-platform and the bottom-platform are configured to slide in relation to each other and grind material positioned between the top-grinding nodule and the bottom-grinding nodule into fine particles.

### CROSS-REFERENCE TO RELATED APPLICATION(S)

The present application is related to and claims priority to U.S. Provisional Patent Application No. 63/204,357 filed Sep. 29, 2020, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of grinders for grinding herbs, tobacco, marijuana, and the like of existing art and more specifically relates to manual herb grinders.

### RELATED ART

In general, tobacco and botanical herb grinders are cylindrical devices divided into two halves with sharp pegs or teeth aligned such that when the halves are rotated with respect to each other, the material inside is shredded. Herb grinders are made from wood, plastic or metal, and may be manual or electric. They are commonly used for refining marijuana or tobacco, as well as in the kitchen for crushing spices and herbs. Traditional grinders have several problems, one being that they do not provide means to help place grinded material into a smoking vessel. Additionally, these devices may be bulky and are not convenient for transporting. A suitable solution is desired.

U.S. Pat. No. 2018/0206675 to Mennillo relates to a toothless herb grinder system. The described toothless herb grinder system includes a system and method for grinding herbs, tobacco, marijuana and the like. The toothless herb grinder system comes in two preferred embodiments one of two piece and one of four pieces. The first embodiment of the toothless herb grinder system herein is comprised of two textured halves used for the compression and grinding process. The upper and lower halves are toothless, as they are carved with maze pattern system to shred the herbs placed in the grinder. The upper half is made of a convex maze pattern. The lower half is concave and the maze pattern is carved at the bottom of an internal bore. The material to be ground is placed and received at the bottom of the lower half. The second embodiment of the toothless herb grinder system herein is comprised of a top member, two tubular housing members and a bottom lid member. The top member is made of a convex maze pattern. The first tubular housing member having a grinding disk in the middle of its internal bore. The material to be ground is placed in the first tubular housing member, on top of the grinding disk. This construction provides an increased rapidity, uniformity and fineness of the grinding, when compared to grinders using a vertical teeth system.

### SUMMARY OF THE INVENTION

In view of the foregoing disadvantages inherent in the known grinder art, the present disclosure provides a novel finger-operated herb grinder. The general purpose of the present disclosure, which will be described subsequently in greater detail, is to provide an effective and efficient finger-operated herb grinder.

A finger-operated herb grinder is disclosed herein. The finger-operated herb grinder includes a grinder assembly having a top-platform and a mating bottom-platform connected by a connecting strap. The top-platform includes a top-grinding nodule and a finger retaining strap and the bottom-platform includes a bottom-grinding nodule, a hollow inner volume, and a thumb retaining strap. A dispensing aperture is formed between the top-platform and the bottom-platform (when located adjacent one another) and is configured to dispense grinded-material therethrough. The top-platform and the bottom-platform are configured to slide in relation to each other via manual means and grind material positioned between the top-grinding nodule and the bottom-grinding nodule into fine particles. The finger-operated herb grinder dispenses ground Cannabis in a format that easily allows its collection on rolling papers, bowls, and other consumption apparatuses and methods.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a finger-operated herb grinder, constructed and operative according to the teachings of the present disclosure.

FIG. 1 is a side view of a finger-operated herb grinder during an ‘in-use’ condition, according to an embodiment of the disclosure.

FIG. 2 is a perspective view of the finger-operated herb grinder of FIG. 1, according to an embodiment of the present disclosure.

FIG. 3 is a perspective view of the finger-operated herb grinder of FIG. 1, according to an embodiment of the present disclosure.

FIG. 4A is a side view of the finger-operated herb grinder of FIG. 1, according to an embodiment of the present disclosure.

FIG. 4B is a side view of the finger-operated herb grinder of FIG. 1, according to an embodiment of the present disclosure.

FIG. 5 is a perspective view of the finger-operated herb grinder of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a grinder and more particularly to a finger-operated herb grinder as used to improve the preparation of Cannabis for consumption.

Generally, the finger-operated herb grinder includes a finger-operated marijuana grinder and dispenser comprising two mating platforms with opposing grinding nodules for grinding marijuana into useable pieces. The platforms are held together via a strap which connects them, and opposing magnets hold the platforms together. Elasticized finger bands are provided for means to hold the fingers to the platforms during a grinding and dispensing procedure. The bottom platform features slits between the grinding nodules. The bottom tray includes a hollow interior acting as a kief tray. The narrow slits between the nodules on the bottom platform allow kief to slide into the kief tray as the marijuana is being ground into useable pieces. The grinding nodules are removeable from the bottom platform for accessing the kief tray portion of the bottom platform. Separate apertures for dispensation of ground Cannabis and kief are also provided. A plug is included for application to the aperture intended for dispensation of kief.

In a preferred embodiment, the platform segments of the finger-operated herb grinder are made of acrylonitrile butadiene styrene (ABS) with coating of polytetrafluoroethylene (PTFE), and each measures approximately three inches in length by one and half inches in width by one inch in height (3″×1.5″×1″).

On the platform intended for top placement during use, a stainless-steel plate with textured surface is permanently affixed to the interior plane. On the bottom-center of a widthwise sidewall of this same top-placement platform is a (3D) semicircular aperture. An open slot is featured within the opposite widthwise sidewall, and a columnar shaft, made of stainless steel, is hosted within this open slot. Attached to and projecting from the same shaft-hosting sidewall is a fabric strap. The opposite endpoint of said fabric strap attaches to the widthwise sidewall of a sliding tray, made of stainless steel and with textured surface. The flooring of this sliding tray is meshed, and rows of textured projections on the sliding tray reveal open channels of this meshed flooring. This tray slides within confined tracks of the remaining platform. Directly below this sliding tray of this platform is an open compartment for the collection of kief. On the top-center of a widthwise sidewall of this same bottom-placement platform is a semicircular aperture, which is aligned with the semicircular aperture featured on the top-placement platform. On a bottom corner of this same widthwise sidewall is an aperture that opens to the kief-collection compartment. An attached plug fits within this aperture.

On the interior planes of each platform, and at endpoint corners opposite the widthwise sidewall that hosts the fabric strap that connects said platforms, are magnets. The magnets of each platform are in alignment to those of the opposite platform. On the exterior planes of each platform, and opposite their textured-surface planes, is an elastic fabric loop, and through which a thumb/finger may be inserted for manual control during use of the device. The textured surfaces on the platforms of the finger-operated herb grinder may include projecting nodules in various sizes and shapes, and in various patterns. The textured surface on the top platform of the finger-operated herb grinder may be on a separate plate that attaches to its hosting platform by spring(s), and to allow compressing of Cannabis in addition to grinding.

In other variations of the finger-operated herb grinder multiple finger straps may be provided, and the straps may be replaced with other securing methods, such as but not limited to projecting rings. The finger-operated herb grinder may include a bladed scraping tool for use within the kief-hosting compartment, and said bladed scraping tool may be included with or may replace the columnar tool.

A method of using the finger-operated herb grinder is as follows: A user may insert their finger into a finger retaining strap and their thumb into a thumb retaining strap ensuring that the bottom-platform having a removable bottom-grinding nodule is in a bottom position, and may then separate their finger and thumb to open the two platforms of the finger-operated herb grinder. The user may then apply a Cannabis bud on the textured bottom-grinding nodule, and then close the two platforms together. The user may then slide his/her thumb and finger together to grind the hosted Cannabis. The Cannabis is broken down to composition appropriate for consumption, and kief released in this process will fall into a hollow inner volume of the bottom-platform. The user may then simply tilt the finger-operated herb grinder to empty its ground Cannabis through a circular dispensing aperture. In this procedure, the Cannabis can be applied to a rolling paper, bowl, or other device in a uniform fashion and method.

The user may then remove the removable cap from the kief-distribution aperture, thereby opening the kief-distribution aperture to access the kief produced during a grinding process. The kief can be accessed without direct contact with the hands or fingers of the user. To further empty the hollow inner volume of the bottom-platform, the user may separate the two platforms and slide back the bottom-grinding nodule to open the hollow inner volume. The user may also access a shaft of the device to further remove kief from the hollow inner volume, and without direct contact with the hand/fingers of the user.

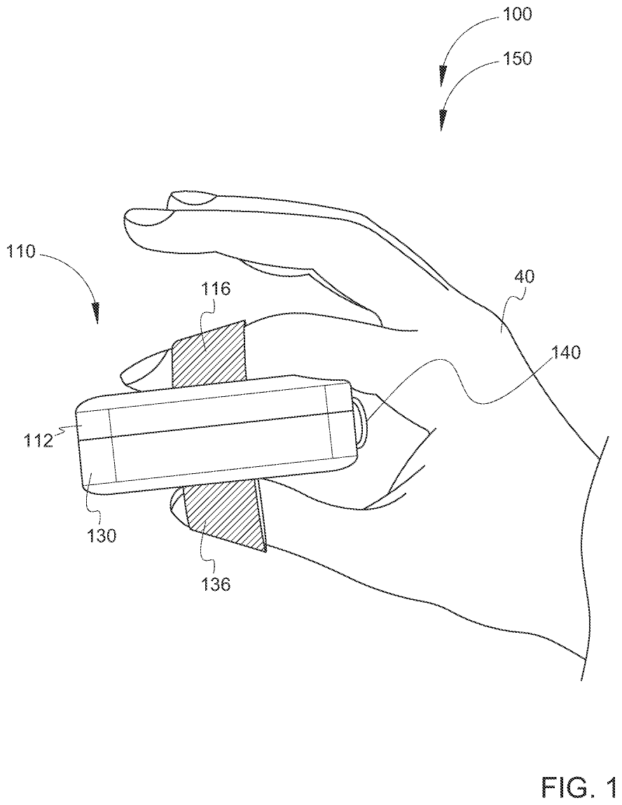

Referring now more specifically to the drawings by numerals of reference, there is shown in FIGS. 1-5, various views of a finger-operated herb grinder 100.

FIG. 1 shows a finger-operated herb grinder 100 during an ‘in-use’ condition 150, according to an embodiment of the present disclosure. Here, the finger-operated herb grinder 100 may be beneficial for use by a user 40 to grind herbs, tobacco, marijuana, and the like. As illustrated, the finger-operated herb grinder 100 may include a grinder assembly 110 having a top-platform 112 and a mating bottom-platform 130 connected by a connecting strap 140. The top-platform 112 and the bottom-platform 130 are configured to slide in relation to each other and grind material such as but not limited to Cannabis, positioned between the top-platform 112 and the bottom-platform 130 into fine particles. In its use, the finger-operated herb grinder 100 can produce and dispense ground Cannabis very easily and conveniently, and without a need to touch the Cannabis, thus avoiding finger contact with any particles, oils, and scents produced in the process.

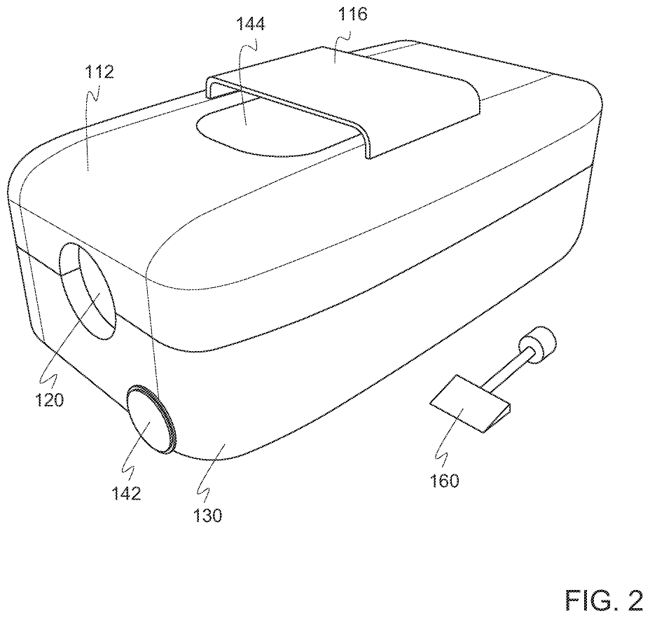

FIG. 2 shows the finger-operated herb grinder 100 of FIG. 1, according to an embodiment of the present disclosure. As above, the finger-operated herb grinder 100 may include the grinder assembly 110 having the top-platform 112 and the mating bottom-platform 130 connected by the connecting strap 140. The top-platform 112 includes a top-grinding nodule 114 and a finger retaining strap 116. The bottom-platform 130 includes a bottom-grinding nodule 132, a hollow inner volume 134, a thumb retaining strap 136, and a kief-distribution aperture 138 in communication with the hollow inner volume 134. A dispensing aperture 120 is formed between the top-platform 112 and the bottom-platform 130 and is configured to dispense grinded-material therethrough. The top-platform 112 includes a first semi arcuate portion of the dispensing aperture 120 and the bottom-platform 130 includes a second semi arcuate portion of the dispensing aperture 120. The top-platform 112 and the bottom-platform 130 further comprise finger-indentations 144. The finger-indentations 144 preferably comprise a textured-surface for assisting with gripping of the finger-operated herb grinder 100. The finger retaining strap 116 and the thumb retaining strap 136 are positioned in alignment with a respective one of the finger-indentations 144.

According to one embodiment, the finger-operated herb grinder 100 may be arranged as a kit. In particular, the finger-operated herb grinder 100 may further include a tool 160 configured to assist a user with pushing the material through a series of slits 139 into the hollow inner volume 134. The grinder assembly 110 may further include a tool-hosting aperture for storage of the tool 160.

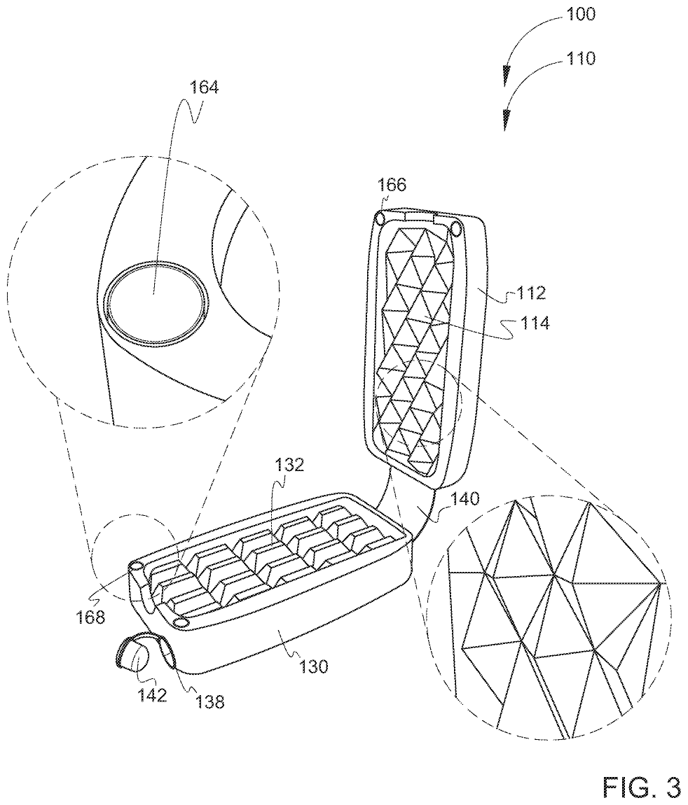

FIG. 3 is a perspective view of the finger-operated herb grinder 100 of FIG. 1, according to an embodiment of the present disclosure. The finger-operated herb grinder 100 is comprised of the top-platform 112 and the bottom-platform 130 connected by the connecting strap 140. The connecting strap 140 is positioned opposite to the dispensing aperture 120 and comprises a flexible fabric material. As shown, the finger-operated herb grinder 100 includes a series of magnetic fasteners 164 or other suitable fasteners such as clips or clasps. In a preferred embodiment, the series of magnetic fasteners 164 includes top-platform magnets 166 and mating bottom-platform magnets 168. The top-platform magnets 166 are in alignment with the bottom-platform magnets 168. The grinder assembly 110 may further include a removable cap 142 for sealing the kief-distribution aperture 138. The kief-distribution aperture 138 is configured to dispense the grinded-material (kief) collected in the hollow inner volume 134 of the bottom-platform 130.

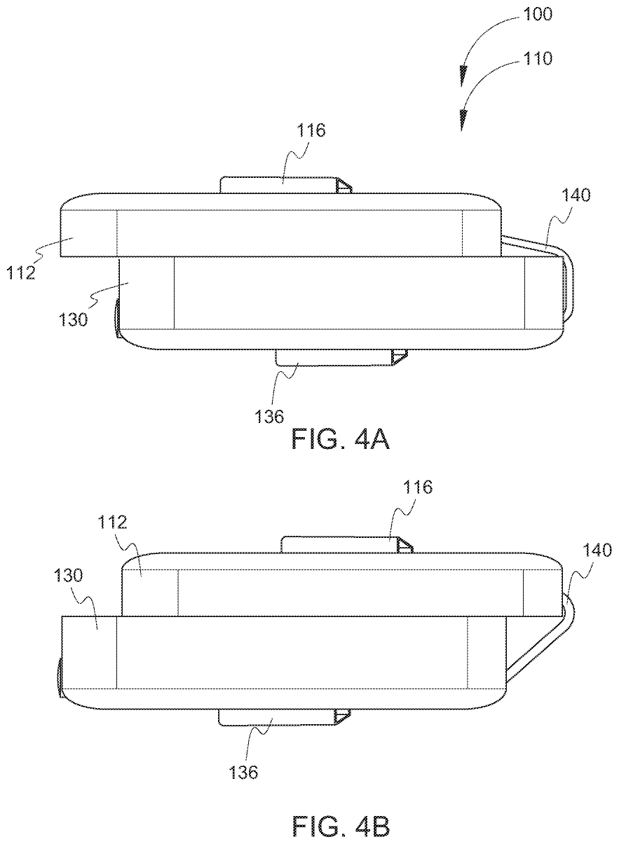

FIG. 4A is a side view of the finger-operated herb grinder 100 of FIG. 1 in a first-position, according to an embodiment of the present disclosure. FIG. 4B is a side view of the finger-operated herb grinder of FIG. 1 in a second-position, according to an embodiment of the present disclosure. As shown, the top-platform 112 and the bottom-platform 130 are configured to slide in relation to each other and grind material positioned between the top-grinding nodule 114 and the bottom-grinding nodule 132 into fine particles. The top-platform 112 includes the finger retaining strap 116 and the bottom-platform 130 features the thumb retaining strap 136. The finger retaining strap 116 and the thumb retaining strap 136 include fabric loops configured to receive and secure a finger and a thumb of a user respectively. The finger retaining strap 116 and the thumb retaining strap 136 are elasticized and configured to expand and retract. As illustrated, the finger retaining strap 116 and the thumb retaining strap 136 are positioned on an exterior plane of the top-platform 112 and bottom-platform 130 respectively.

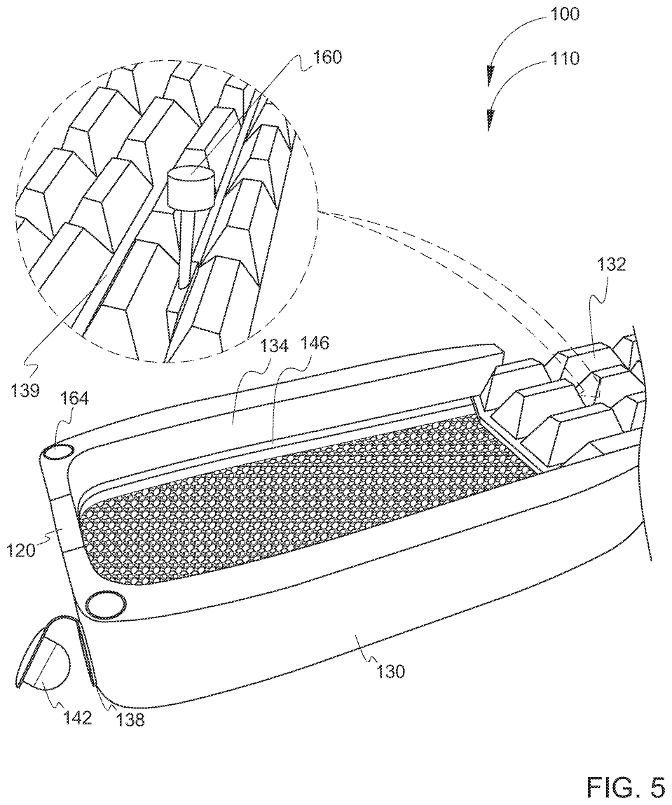

FIG. 5 is a perspective view of the finger-operated herb grinder 100 of FIG. 1, according to an embodiment of the present disclosure. As shown, the bottom-grinding nodule 132 is removable providing access to the hollow inner volume 134 of the bottom-platform 130. The bottom-grinding nodule 132 is hosted on a track 146 and configured to slide along the track 146. The bottom-grinding nodule 132 further includes a series of slits 139 allowing for passage of terpene- and cannabinoid-containing trichomes produced during a grinding process.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A finger-operated herb grinder, the finger-operated herb grinder comprising:
a grinder assembly including,
a top-platform having,
a top-grinding nodule, and
a finger retaining strap,
a bottom-platform having,
a bottom-grinding nodule,
a hollow inner volume,
a thumb retaining strap, and
a kief-distribution aperture in communication with said hollow inner volume,
a connecting strap connecting said top-platform and said bottom-platform;
a series of magnetic fasteners, and
a dispensing aperture formed between said top-platform and said bottom-platform configured to dispense grinded-material therethrough, and
wherein said top-platform and said bottom-platform are configured to slide in relation to each other and grind material positioned between said top-grinding nodule and said a bottom-grinding nodule into fine particles.

2. The finger-operated herb grinder of claim 1, wherein said finger retaining strap and said thumb retaining strap include fabric loops configured to receive and secure a finger and a thumb of a user respectively.

3. The finger-operated herb grinder of claim 2, wherein said finger retaining strap and said thumb retaining strap are elasticized.

4. The finger-operated herb grinder of claim 3, wherein said finger retaining strap and said thumb retaining strap are positioned on an exterior plane of said top-platform and bottom-platform respectively.

5. The finger-operated herb grinder of claim 4, wherein said top-platform and said bottom-platform further comprise finger-indentations, said finger retaining strap and said thumb retaining strap being positioned in alignment with a respective one of said finger-indentation.

6. The finger-operated herb grinder of claim 5, wherein said finger-indentations comprise a textured-surface.

7. The finger-operated herb grinder of claim 1, wherein said series of magnetic fasteners includes top-platform magnets and mating bottom-platform magnets.

8. The finger-operated herb grinder of claim 7, wherein said top-platform magnets are in alignment with said bottom-platform magnets.

9. The finger-operated herb grinder of claim 1, wherein said bottom-grinding nodule includes a series of slits.

10. The finger-operated herb grinder of claim 1, wherein said kief-distribution aperture is configured to dispense said grinded-material collected in said hollow inner volume of said bottom-platform.

11. The finger-operated herb grinder of claim 10, wherein said grinder assembly further includes a removable cap for sealing said kief-distribution aperture.

12. The finger-operated herb grinder of claim 1, wherein said material is a smokable material including Cannabis.

13. The finger-operated herb grinder of claim 1, wherein said connecting strap is positioned opposite to said dispensing aperture.

14. The finger-operated herb grinder of claim 13, wherein said connecting strap comprises a flexible fabric material.

15. The finger-operated herb grinder of claim 1, wherein said bottom-grinding nodule is removable providing access to said hollow inner volume of said bottom-platform.

16. The finger-operated herb grinder of claim 15, wherein said bottom-grinding nodule is hosted on a track.

17. The finger-operated herb grinder of claim 9, wherein said grinder assembly further includes a tool configured to assist a user with pushing said material through said series of slits into said hollow inner volume.

18. The finger-operated herb grinder of claim 17, wherein said grinder assembly further includes a tool-hosting aperture for storage of said tool.

19. The finger-operated herb grinder of claim 1, wherein said grinder assembly measures approximately 3 inches in length by 1.5 inches in width by 1 inch in height.

20. A finger-operated herb grinder, said finger-operated herb grinder comprising:
a grinder assembly including,
a top-platform having,
a top-grinding nodule, and
a finger retaining strap,
a bottom-platform having,
a bottom-grinding nodule,
a hollow inner volume,
a thumb retaining strap, and
a kief-distribution aperture in communication with said hollow inner volume,
a connecting strap connecting said top-platform and said bottom-platform;
a series of magnetic fasteners, and
a dispensing aperture formed between said top-platform and said bottom-platform configured to dispense grinded-material therethrough, and
wherein said finger retaining strap and said thumb retaining strap include fabric loops configured to receive and secure a finger and a thumb of a user respectively;
wherein said finger retaining strap and said thumb retaining strap are elasticized;
finger retaining strap and said thumb retaining strap are positioned on an exterior plane of said top-platform and bottom-platform respectively;
wherein said top-platform and said bottom-platform further comprise finger-indentations, said finger retaining strap and said thumb retaining strap being positioned in alignment with a respective one of said finger-indentation;
wherein said finger-indentations comprise a textured-surface;
wherein said top-platform and said bottom-platform are configured to slide in relation to each other and grind material positioned between said top-grinding nodule and said a bottom-grinding nodule into fine particles;
wherein said series of magnetic fasteners includes top-platform magnets and mating bottom-platform magnets;
wherein said top-platform magnets are in alignment with said bottom-platform magnets;
wherein said bottom-grinding nodule includes a series of slits;
wherein said kief-distribution aperture is configured to dispense said grinded-material collected in said hollow inner volume of said bottom-platform;
wherein said grinder assembly further includes a removable cap for sealing said kief-distribution aperture;
wherein said material is a smokable material including Cannabis;
wherein said connecting strap is positioned opposite to said dispensing aperture;
wherein said bottom-grinding nodule is removable providing access to said hollow inner volume of said bottom-platform;
wherein said bottom-grinding nodule is hosted on a track;
wherein said grinder assembly further includes a tool configured to assist a user with pushing said material through said series of slits into said hollow inner volume; and
wherein said grinder assembly further includes a tool-hosting aperture for storage of said tool.
